(19) United States
(12) Patent Application Publication
(10) Pub. No.: US 2011/0136381 A1
(43) Pub. Date: Jun. 9, 2011

(54) BIDIRECTIONAL PLUG HAVING SHORT CIRCUIT PREVENTION CIRCUIT

(75) Inventor: Seong Bean Cho, Bucheon-si (KR)

(73) Assignee: CLEAR ELECTRONICS, INC, Bucheon-si (KR)

(21) Appl. No.: 12/598,991

(22) PCT Filed: Apr. 2, 2009
(86) PCT No.: PCT/KR09/01688

§ 371 Date: Nov. 5, 2009

(30) Foreign Application Priority Data
May 19, 2008 (KR) 10-2008-0045908

(51) Int. Cl. H01R 13/66

(52) U.S. Cl. 439/620.01

(57) ABSTRACT

Disclosed herein is a bidirectional plug having a short circuit prevention circuit. The bidirectional plug includes a body part, a terminal part, connecting terminals, and a short circuit prevention circuit. The terminal part is connected to one end of the body part, and is inserted into an interface port of a communication device. The connecting terminals are respectively provided on two opposite surfaces of the terminal part, and make contact with a connecting pin provided in the interface port regardless of a direction from which the terminal part is inserted. The short circuit prevention circuit prevents a remaining connecting terminal, provided on a surface of the terminal part which is not in contact with a connecting pin, from making electrical contact with a tension ground pin provided in the interface port.

### BACKGROUND OF THE INVENTION

1. Field of the Invention

The present invention relates generally to a bidirectional plug having a short circuit prevention circuit, and, more particularly, to a bidirectional plug having a short circuit prevention circuit, which is provided with connecting terminals on two sides of a terminal part so as to enable the plug to be inserted into an interface port in any direction, and which is capable of preventing the plug or a communication device from being damaged due to a short circuit which is generated when a connecting terminal is brought into contact with the tension ground pin of an interface port because the connecting terminals are provided on two surfaces of the terminal part.

2. Description of the Related Art

There are many recent cases of data being exchanged between communication devices, such as computers, MPEG Audio-Layer 3 (MP3) players, Personal Data assistants (PDAs), digital cameras, and mobile phones.

In order to enable data exchange between communication devices, the communication devices are provided with interface ports, and plugs are inserted into the interface ports of the communication devices, thus acting as intermediaries for data exchange between the two communication devices.

A plug, such as USB memory, does not act as an intermediary for data exchange between communication devices, but functions to transmit data stored in the USB memory to a communication device, or to receive data and transmit the data to a communication device.

Each of the plugs which act as intermediaries for data exchange includes a body part and a terminal part connected to the body part. The terminal part is inserted into an interface port, and the connecting terminal of the terminal part is connected to a connecting pin provided in the interface, thereby enabling data exchange.

A typical plug is inconvenient in that a user must pay attention to the direction in which the plug is inserted into an interface port because a connecting terminal is provided on one surface of the terminal part of the plug.

Accordingly, Korean Patent No. 0424781 discloses a “USB Storage Device having Bidirectional Terminal USB Plug” in which connecting terminals are provided on two surfaces of a terminal part and, regardless of the direction in which a user inserts the plug, a connecting terminal of the plug makes contact with the connecting pin of an interface port.

However, the interface port is also provided with a tension spring which reliably brings the connecting terminal into contact with the connecting pin by pushing the terminal part while holding the terminal part of the plug, in addition to connecting pins. The tension spring functions as a ground terminal.

Accordingly, when the connecting terminals are provided on both surfaces of the terminal part of the plug, one connecting terminal is brought into contact with the connecting pin and, at the same time, the other connecting terminal is also brought into contact with the tension spring, so that there may occur a situation which causes an accidental short circuit, thereby damaging a communication device or the plug.

In order to prevent such an accidental short circuit, Korean Patent No. 0626909 discloses a “USB Plug having Two Side Parts selectively connectable to USB Port” in which ribs protrude from a terminal part and connecting terminals are provided in slots defined by the ribs.

Accordingly, a connecting pin of an interface port is inserted into the slot and comes into contact with one connecting terminal and, at the same time, a tension ground pin is brought into contact with the rib, so that the occurrence of an accidental short circuit is prevented.

However, although the patented technology is configured to prevent a short circuit accident using the ribs, a plurality of ribs is formed on two surfaces of the terminal part in a longitudinal direction, the structure is complicated, the manufacturing cost is increased, and the overall thickness of the terminal part is increased due to the ribs. In contrast, when the ribs are removed, the thickness of the terminal part is excessively decreased, so that there is a high danger that the terminal part may be damaged by a weak external impact.

### SUMMARY OF THE INVENTION

Accordingly, the present invention has been made keeping in mind the above problems occurring in the prior art, and an object of the present invention is to provide a bidirectional plug which is provided with an electrical short circuit prevention means using a short circuit prevention circuit, rather than a mechanical short circuit prevention means such as ribs or slots, so as to prevent a short circuit accident which may occur because connecting terminals are provided on two surfaces of a terminal part, thereby reducing the manufacturing cost and eliminating concern about the excessive thickness of the terminal part or easy damage to the plug by a weak external impact.

In order to accomplish the above object, the present invention provides a bidirectional plug having a short circuit prevention circuit, including a body part; a terminal part connected to one end of the body part, and configured to be inserted into an interface port of a communication device; connecting terminals respectively provided on two opposite surfaces of the terminal part, and configured to make contact with a connecting pin provided in the interface port regardless of a direction from which the terminal part is inserted; and a short circuit prevention circuit for preventing a remaining connecting terminal, provided on a surface of the terminal part which is not in contact with a connecting pin, from making electrical contact with a tension ground pin provided in the interface port.

The short circuit prevention circuit is connected to power supply lines of the connecting terminals provided on the two surfaces of the terminal part, and includes electronic devices for allowing forward electrical connection and blocking reverse electrical.

The electronic devices of the short circuit prevention circuit are diodes which are respectively connected to power supply lines of the connecting terminals on the two surfaces of the terminal part so that cathode terminals of the diodes are connected to the body part and anode terminals of the diodes are connected to the interface port, or transistors which are respectively connected to power supply lines of the connecting terminals on the two surfaces of the terminal part so that collector terminals of the transistors are connected to the body part and emitter terminals of the transistors are connected to the interface port.

A first resistor is disposed between each of base terminals of the transistors and each of the power supply lines provided opposite the terminal part, and a second resistor is disposed between the first resistor and each of the ground lines of the connecting terminals.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view showing a plug according to an example of the present invention;

FIG. 2 is a circuit diagram showing a short circuit prevention circuit according to an embodiment of the present invention; and

FIG. 3 a circuit diagram showing a short circuit prevention circuit according to another embodiment of the present invention.

### DESCRIPTION OF THE PREFERRED EMBODIMENTS

Reference now should be made to the drawings, in which the same reference numerals are used throughout the different drawings to designate the same or similar components.

The present invention will be described in detail below with reference to the accompanying drawings.

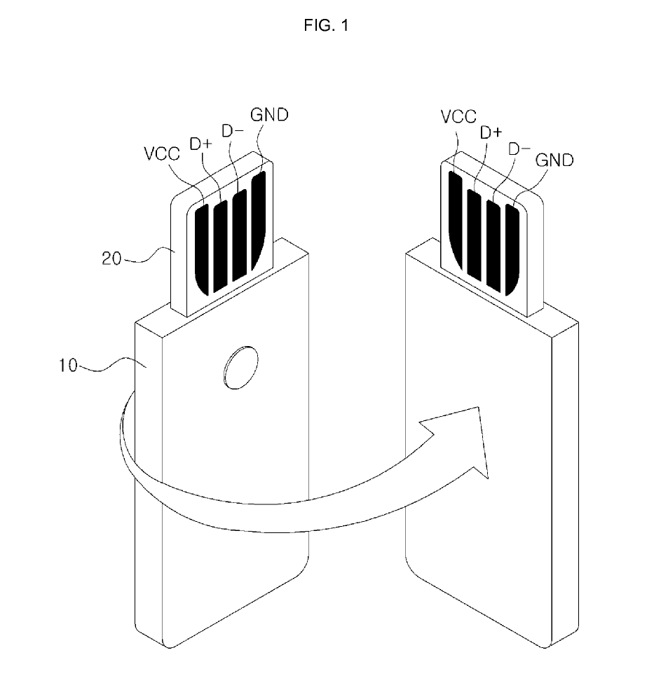

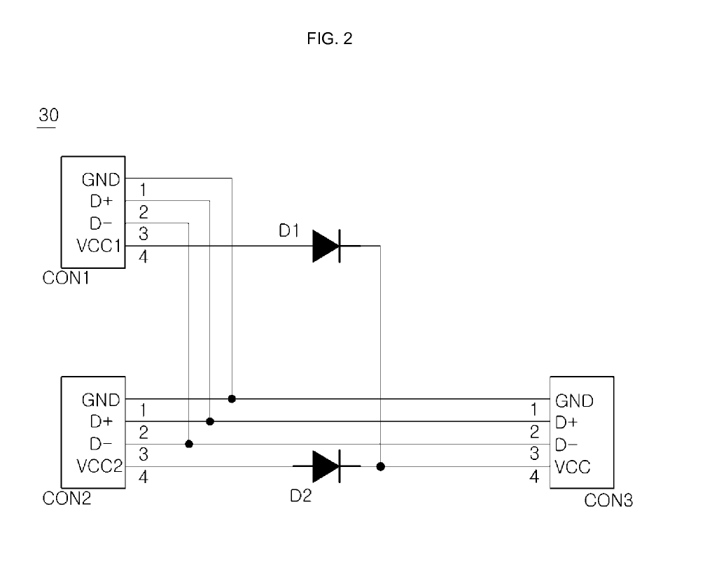

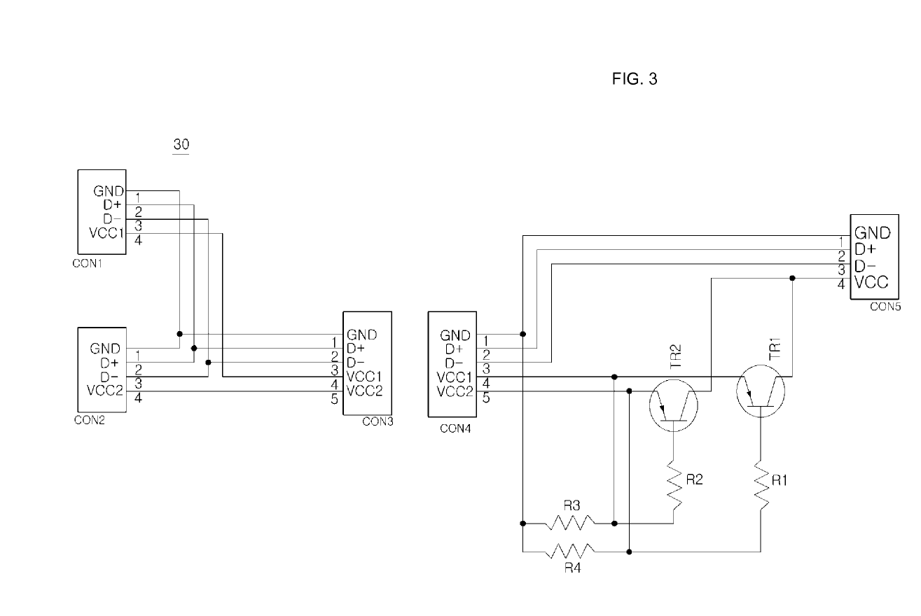

FIG. 1 is a perspective view showing a plug according to an example of the present invention, FIG. 2 is a circuit diagram showing a short circuit prevention circuit according to an embodiment of the present invention, and FIG. 3 a circuit diagram showing a short circuit prevention circuit according to another embodiment of the present invention.

As shown in FIG. 1, the plug according to the present invention includes a body part 10, a terminal part 20, and connecting terminals. A short circuit prevention circuit 30 is provided in the body part 10 or terminal part 20.

Since the body part, the terminal part and the connecting terminal are not significantly different from those of the conventional plug, they will be described briefly.

The body part 10 is connected to one end of the terminal part (the end of the terminal part opposite the end of the terminal part which is inserted into an interface port). The body part 10 may be memory which stores a variety of types of data, or a medium which simply acts as an intermediary for data exchange between communication devices without storing data.

For reference, FIG. 1 shows the plug in which the body part is memory. Two plugs for data exchange between communication devices are provided to be connected to the two communication devices, and are connected to each other by a cable.

The terminal part 20 is inserted into the interface port of a communication device, is made of an insulating material, and is a kind of a Printed Circuit Board (PCB). The connecting terminals are conductors to be connected to the connecting pins of the interface port, and are circuit patterns respectively printed on two surfaces of the PCB.

Each of the connecting terminals generally includes a power supply line (VCC (including VCC1 or VCC2)), a ground wire (GND), and a positive wire (D+) and a negative wire (D−) for data communication.

The connecting terminals are provided on two surfaces of the terminal part 20 in the same shape, as shown in FIG. 1, and are connected to respective connecting pins even when the terminal part 20 is inserted into the interface port from any direction.

Referring to FIGS. 2 and 3, a short circuit prevention circuit 30 will be described below.

Since the connecting terminals are provided on the two surfaces of the terminal part as described above, a connecting terminal on one surface of the terminal part, which should not make contact, makes contact with a tension ground pin provided in the interface port, so that there is a strong possibility of a short circuit occurring.

This will be described in detail below.

In compliance with regulations regarding the interface port, the data positive line D+ and negative line D− of the connecting terminals do not make contact with the tension ground pin. However, since there may be exceptions, a problem can be solved by connecting mechanical structures or electronic devices for preventing a short circuit to the data positive line D+ and the data negative line D−.

Meanwhile, since the tension ground pin is also a ground line, a problem does not occur when the ground line GND of the connecting terminals makes contact with the tension ground pin.

The case where the power supply line VCC makes contact with the tension ground pin is problematic. That is, when the power supply line makes contact with the tension ground pin, a short circuit may occur, thereby considerably damaging the plug and a communication device to which the plug is connected.

Accordingly, in order to prevent such a short circuit, the short circuit prevention circuit 30 of the present invention functions to block electrical contact between the connecting terminal and the tension ground pin even when they make contact with each other.

The short circuit prevention circuit 30 of the present invention is simplified to minimize increases in the manufacturing cost and the volume of the plug, as shown in the drawing.

The short circuit prevention circuit 30 may be provided in the terminal part 20 or in the body part 10. When the short circuit prevention circuit 30 is provided in the body part 10, the short circuit prevention circuit 30 can be installed in an empty space inside the body part 10, so that there is the advantage of not increasing the volume (size, length and thickness) of the plug.

Each of the short circuit prevention circuits 30 uses, as core parts, electronic devices which are respectively connected to the power supply lines VCC1 and VCC2 disposed on the two surfaces of the terminal part, which enable an electrical connection between a power supply line disposed on one surface of the terminal part and a ground pin, and which block an electrical connection between a power supply line disposed on the other surface of the terminal part and a tension ground pin. The electronic devices may be diodes D1 and D2 or transistors TR1 and TR2.

FIG. 2 is a circuit diagram showing a short circuit prevention circuit provided in the terminal part 20 and configured to use diodes D1 and D2, and FIG. 3 is a circuit diagram showing a short circuit prevention circuit provided in the body part 10 and configured to use transistors TR1 and TR2.

Here, it will be apparent that diodes or transistors can be selectively used regardless of whether the short circuit prevention circuit is provided in the terminal part or in the body part.

When the short circuit prevention circuit 30 is provided in the body part 10, the same lines GND, D+ or D− of the connecting terminals provided on two surfaces of the terminal part 20 are connected to each other within the body part 10, while two power supply lines VCC1 and VCC2 are not connected to each other before a connection to the short circuit prevention circuit. Although the same connecting terminals are not connected to each other within the body part, this is preferable from the point of view of a reduction in cost and volume.

In the drawings, CON1 refers to the connecting terminal of a part which is provided on one surface of the terminal part 20, is inserted into the port and is then connected to a connecting pin (or a tension ground pin), CON2 refers to the connecting terminal of a part which is provided on the other surface of the terminal part 20, is inserted into the interface port, and is then connected to the tension spring, CON3 refers to the connecting terminal of a part which is connected to the body part 10, CON4 refers to the connecting terminal part of the body part 10 connected to CON3, and CON5 refers to memory provided in the body part 10 or a connecting terminal part connected to a cable connected to the main part.

Referring to FIG. 2, the construction and operation of the short circuit prevention circuit using diodes D1 and D2 will now be described.

As is well known, a diode passes current in one direction only. That is, a diode has the characteristic of passing forward current and blocking reverse current.

On the basis of this diode characteristic, diodes D1 and D2 are connected to two power supply lines VCC1 and VCC2 so that the anode terminals thereof are connected to the port and the cathode terminals thereof are connected to the body part, thereby allowing conduction between one power supply line VCC1 or VCC2 and the connecting pin (ON) and blocking conduction between the other power supply line VCC2 or VCC1 and the tension spring (OFF).

For example, when line CON1 is connected to the connecting pin of the interface port, lines GND, D+ and D− of CON1 are connected to CON3 and operate normally, and line VCC1 transmits power current to CON3 via the diode D1. Meanwhile, lines D+ and D− of CON2 are not connected to a tension ground pin due to the structure of the interface port, and line GND does not cause a problem because they are the same type of ground wires even when line GND is brought into contact with the tension ground pin, and line VCC2 does not affect the operation of the plug because the diode D2 blocks reverse current flowing from the body part, that is, electrical contact between line VCC2 of CON2 and line VCC of CON3 even when line VCC2 is brought into contact with the tension ground pin.

Next, referring to FIG. 3, the construction and operation of the short circuit prevention circuit using transistors TR1 and TR2 will now be described.

As is well known, a transistor has the characteristic of allowing or blocking conduction depending on the amplitude of voltage applied to a base terminal thereof (HIGH or LOW).

On the basis of this transistor characteristic, the transistors TR1 and TR2 are connected to two power supply lines VCC1 and VCC2 so that emitter terminals thereof are connected to the port and the collector terminals thereof are connected to the body part. Accordingly, a LOW signal is input to the base terminal of the transistor on the power supply line to which the connecting pin is connected and a HIGH signal is input to the base terminal of the other transistor, so that the conduction between the power supply line and the ground pin is allowed and the conduction between the other power supply line and the tension ground pin is blocked, thereby preventing an accidental short circuit.

Meanwhile, a first resistor R1 and a second resistor R4 are connected to the base terminal of the transistor TR1, and a first resistor R2 and a second resistor R3 are connected to the base terminal of the transistor TR2. Each of the first resistors is connected between the base terminal of one transistor and the power supply line to which the emitter terminal of the other transistor is connected (the power supply line provided opposite the terminal part), and each of the second resistors is connected between the first resistor and the ground wire.

For example, when CON1 is connected to a connecting pin of the interface port, the lines GND, D+ and D− of CON1 and CON2 operate normally in the same manner as described in conjunction with FIG. 2, VCC1 receives voltage of a specific magnitude from a communication device, and VCC2 is in contact with the tension ground pin or is present in empty space. In order to enable the VCC1 to operate normally and prevent VCC2 from being short-circuited to a tension ground pin, TR1 must allow conduction and TR2 must block conduction, that is, a LOW signal must be input to the base terminal of TR1 and a HIGH signal must be input to the base terminal of TR2.

The base terminal of TR1 which is a transistor connected to the power supply line of VCC1 is connected to the power supply line of VCC2 through R1 and the power supply line of VCC2 is connected to the tension ground pin and grounded, so that the base terminal of TR1 enters a LOW state. Meanwhile, when VCC2 is not connected to the tension ground pin and is present and open in empty space, the base terminal of TR1 is connected to a ground wire GND through R4 (a full down resistor) and enters a LOW state, so that TR1 is turned on. The base terminal of TR2 which is a transistor connected to the power supply line of VCC2 is connected to the power supply line of VCC1 through R2, and is turned to a HIGH state by voltage applied by the communication device, so that TR2 is turned off. As a result, the power supply line of VCC1 is electrically connected to a connecting pin of the interface port and operates normally, and a short circuit does not occur even when the power supply line of VCC2 comes into contact with the tension ground pin of the interface port, thus not affecting the operation of the plug.

According to the present invention configured as described above, the electrical short circuit prevention circuit for blocking electrical contact (blocking the flow of current) between the tension ground pin and the connecting terminal, rather than the mechanically deformation of the terminal part, is provided to prevent a short circuit and the short circuit prevention circuit is simplified, so that it is possible to prevent a short circuit while minimizing an increase in the manufacturing cost, and so that the problem in which the terminal part becomes weak, like that of the conventional bidirectional plug, does not occur because the terminal part is not deformed.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A bidirectional plug having a short circuit prevention circuit, comprising:
a body part;
a terminal part connected to one end of the body part, and configured to be inserted into an interface port of a communication device;
connecting terminals respectively provided on two opposite surfaces of the terminal part, and configured to make contact with a connecting pin provided in the interface port regardless of a direction from which the terminal part is inserted; and
a short circuit prevention circuit for preventing a remaining connecting terminal, provided on a surface of the terminal part which is not in contact with a connecting pin, from making electrical contact with a tension ground pin provided in the interface port.

2. The bidirectional plug as set forth in claim 1, wherein the short circuit prevention circuit is connected to power supply lines of the connecting terminals provided on the two surfaces of the terminal part, and comprises electronic devices for allowing forward electrical connection and blocking reverse electrical.

3. The bidirectional plug as set forth in claim 2, wherein the electronic devices of the short circuit prevention circuit are diodes which are respectively connected to power supply lines of the connecting terminals on the two surfaces of the terminal part so that cathode terminals of the diodes are connected to the body part and anode terminals of the diodes are connected to the interface port.

4. The bidirectional plug as set forth in claim 2, wherein the electronic devices of the short circuit prevention circuit are transistors which are respectively connected to power supply lines of the connecting terminals on the two surfaces of the terminal part so that collector terminals of the transistors are connected to the body part and emitter terminals of the transistors are connected to the interface port.

5. The bidirectional plug as set forth in claim 4, wherein a first resistor is disposed between each of base terminals of the transistors and each of the power supply lines provided opposite the terminal part, and a second resistor is disposed between the first resistor and each of the ground lines of the connecting terminals.
